(19) United States
(12) Patent Application Publication
(10) Pub. No.: US 2006/0193647 A1
(43) Pub. Date: Aug. 31, 2006

(54) Image forming device and image forming method

(76) Inventor: Masanori Asakura, Otsu-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(21) Appl. No.: 11/321,215

(22) Filed: Dec. 29, 2005

(30) Foreign Application Priority Data
Feb. 28, 2005 (JP) 2005-053327

(51) Int. Cl. G03G 15/00

(52) U.S. Cl. 399/13

(57) ABSTRACT

An image forming device includes a casing including a cover capable of being opened and closed, a process unit which is arranged inside the casing and executes a printing process on a printing medium, an image forming unit which is arranged inside the casing and forms an electrostatic latent image on the process unit, and a sensing unit which senses an installation state of the process unit. When the cover is closed, and when the process unit is installed and the sensing unit is activated, power is supplied to the image forming unit.

### BACKGROUND OF THE INVENTION

1. Field of the Invention

The present invention relates to an image forming device and an image forming method. In particular, the present invention relates to an improvement to a method for sensing an installation state of a process unit and a method for supplying power to an image forming unit.

2. Description of the Related Art

In a conventional image forming device, a switch senses whether or not a cover is closed normally. When the cover is not closed normally, the image forming device controls not to operate each mechanism in the image forming device.

When a printer unit is a laser printer as in the conventional image forming device, an image forming device includes (1) a switch for sensing whether or not a toner cartridge, a photoconductive drum and a transfer and fixing unit or the like are installed properly in the image forming device, and (2) a mechanical contact switch for switching to supply or shut off power to an image forming unit, which forms an electrostatic latent image on a process unit. By providing the switches, a satisfactory printing process may be executed while maintaining safety of the image forming device.

However, if the number of components of the image forming device increases, a structure of the image forming device becomes complicated and the manufacturing cost increases.

### SUMMARY OF THE INVENTION

In order to overcome the problems described above, preferred embodiments of the present invention provide an image forming device which enables a structure of the image forming device to be simplified while maintaining safety.

According to a first preferred embodiment of the present invention, an image forming device includes a casing, a process unit, an image forming unit and a sensing unit. The casing includes a cover which can be opened and closed. The process unit is arranged inside the casing. The process unit executes a printing process on a printing medium. The image forming unit is arranged inside the casing. The image forming unit forms an electrostatic latent image on the process unit. The sensing unit senses an installation state of the process unit. When the cover is closed, in case the process unit is installed and the sensing unit is activated, power is supplied to the image forming unit.

According to a second preferred embodiment of the present invention, the image forming unit includes a laser diode.

According to a third preferred embodiment of the present invention, the process unit includes at least a drum unit having a photoconductive drum.

According to the above-described first through third preferred embodiments of the present invention, one sensing unit can sense whether or not the process unit is installed and also switch to supply or shut off power from a power supply unit to the image forming unit. Therefore, while maintaining the safety of the image forming device, a hardware structure of the image forming device can be simplified and a cost required for manufacturing the image forming device can be reduced.

In particular, according to the second preferred embodiment of the present invention, when the cover is closed and the process unit is installed, power is supplied to the laser diode. Therefore, the laser diode can satisfactorily form the electrostatic latent image.

In particular, according to the third preferred embodiment of the present invention, when the cover is closed and the drum unit is installed properly in the image forming device, the image forming unit can execute the process for forming the electrostatic latent image on the drum unit. Therefore, the process for forming the electrostatic latent image on the drum unit can be carried out satisfactorily.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an overview of the entire structure of an image forming device according to a preferred embodiment of the present invention.

FIG. 2 is a block diagram illustrating an example of a structure of the image forming device according to a preferred embodiment of the present invention.

FIG. 3 illustrates an example of a structure near a sensor which senses an installation of a drum unit.

FIG. 4 illustrates an example of the structure near the sensor which senses the installation of the drum unit.

FIG. 5 is a flowchart illustrating a procedure of a process carried out when initializing the image forming unit.

### DETAILED DESCRIPTION OF PREFERRED EMBODIMENTS

With reference to the drawings, a description will be made of various preferred embodiments of the present invention.

1. Structure of Image Forming Device

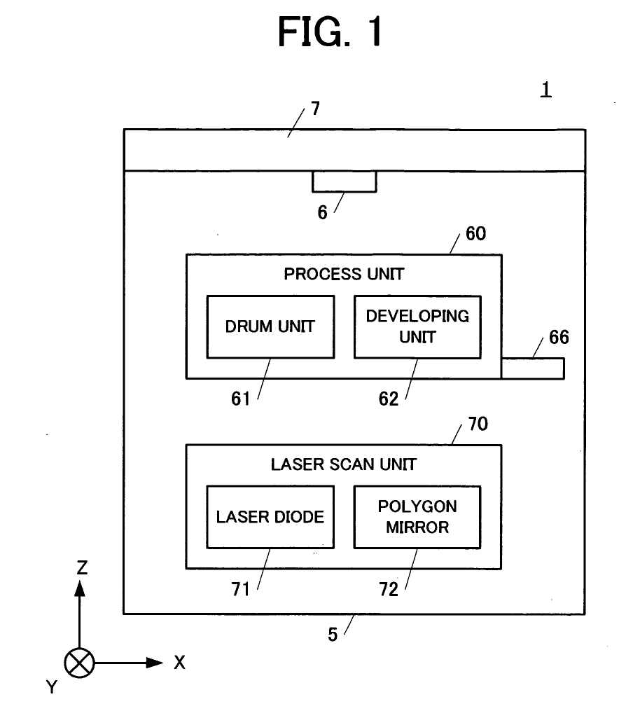

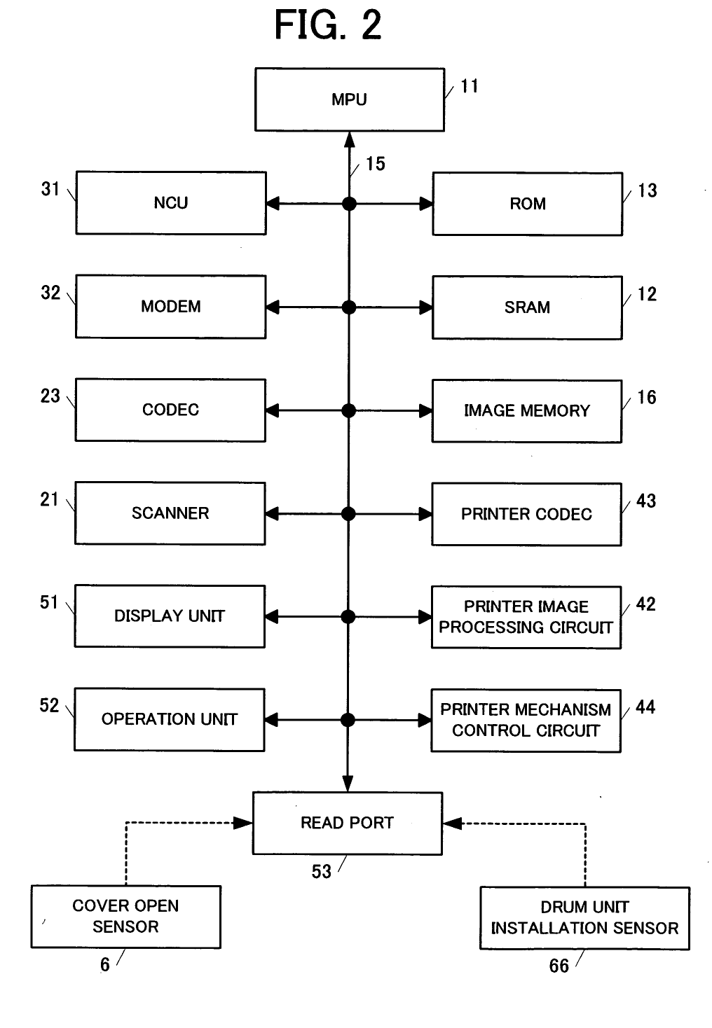

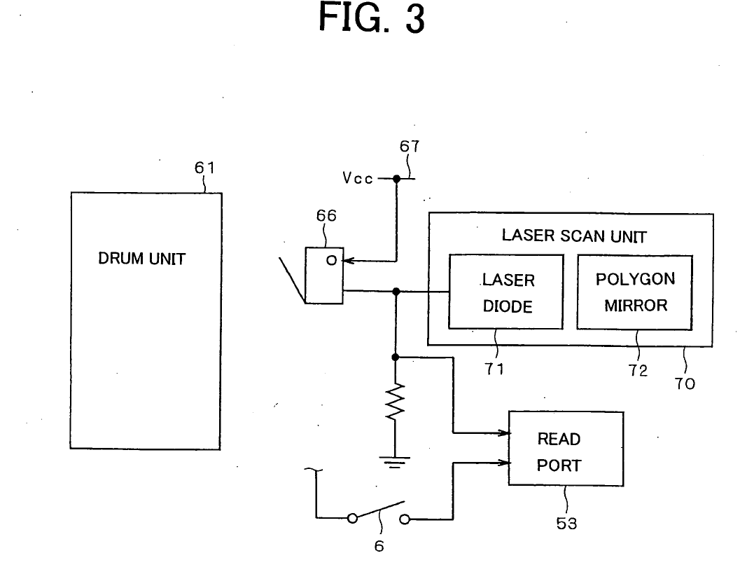

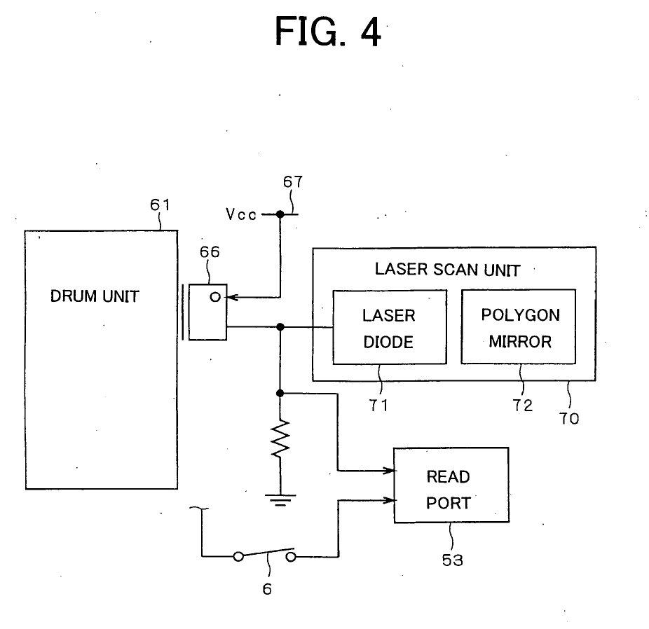

FIG. 1 illustrates an example of an image forming device 1 according to a preferred embodiment of the present invention. FIG. 2 is a block diagram illustrating an example of a structure of the image forming device 1. FIG. 3 and FIG. 4 illustrate an example of a structure near a sensor 66, which senses an installation of a drum unit.

The image forming device 1 is a printer, a copier, a facsimile machine or a Multi-Function Peripheral (MFP) including a printer function, a copier function and a facsimile function, for example. As illustrated in FIG. 1, the image forming device 1 includes a process unit 60, a laser scan unit 70, and sensors 6 and 66. A cover 7 is arranged on an opening of a casing 5 in a manner capable of being opened and closed.

The process unit 60 is an element for executing a printing process on a printing medium by an electrophotographic method. As illustrated in FIG. 1, the process unit 60 is arranged inside the casing 5. The process unit 60 includes a drum unit 61 and a developing unit 62. The drum unit 61 includes at least one of a photoconductive drum, a main charger and a cleaner. The developing unit 62 includes a toner container or the like.

In the present preferred embodiment, the drum unit 61 and the developing unit 62 are separate units. However, the present invention is not limited to such an example. The drum unit 61 and the developing unit 62 may be integral.

The laser scan unit 70 is an image forming unit which carries out an image forming process for forming an image on the photoconductive drum of the drum unit 61. As illustrated in FIG. 1, the laser scan unit 70 is arranged inside the casing 5 and includes a laser diode 71 and a polygon mirror 72. The laser scan unit 70 scans the photoconductive drum charged by a laser light irradiated from the laser diode 71 and reflected by the rotating polygon mirror 72. Accordingly, the laser scan unit 70 can form an electrostatic latent image on the photoconductive drum. That is, the laser scan unit 70 can form an electrostatic latent image on the photoconductive drum of the drum unit 61.

As illustrated in FIG. 3 and FIG. 4, a drum unit installation sensor 66 is a switch including a mechanical contact arranged between a 5V power supply unit 67 and the laser diode 71. When the drum unit 61 is installed properly, the drum unit installation sensor 66 is switched on (activated), as shown in FIG. 4. Meanwhile, when the drum unit 61 is not installed properly, the drum unit installation sensor 66 is switched off (deactivated), as shown in FIG. 3. When the cover 7 is opened, the cover open sensor 6 is switched off (deactivated). When the cover 7 is closed, the cover open sensor 6 is switched on (activated).

In the present preferred embodiment, when the cover open sensor 6 is switched on, power is supplied from a power supply unit (not illustrated) to the process unit 60. When the cover open sensor 6 is switched on and the drum unit installation sensor 66 is switched on, power is supplied from the power supply unit 67 to the laser diode 71.

The scanner 21 is used as an image input unit which inputs image data to the image forming device 1. The image data, which has been scanned by the scanner 21 and binarized, is encoded (compressed) by a Coder-Decoder (CODEC) 23 and stored into an image memory 16. The CODEC 23 encodes the image data in accordance with the Modified Huffman (MH), the Modified Relative Element Address Designate (MR), the Modified MR (MMR) or the Joint Bi-level Image experts Group (JBIG) scheme, for example.

A modulator-demodulator (MODEM) 32 converts digital data (image data) stored in the image memory 16 into an audio frequency signal or converts an audio frequency signal transmitted from outside of the image forming device 1 into digital data. The NCU 31 establishes a connection between a Public Switched Telephone Network (PSTN) and the image forming device 1. The NCU 31 controls an incoming call and an outgoing call.

A printer CODEC 43 decodes (expands) image data, which has been encoded and stored in the image memory 16. A printer image processing circuit 42 executes a smoothing process or a resolution conversion process or the like on the image data, which has been decoded by the printer CODEC 43 and converted into binary bitmap data. The image data, which has been executed with a prescribed processing by the printer image processing circuit 42, is output to the laser diode 71 as a serial data string. The printer CODEC 43 adopts either one of the MH, the MR, the MMR and the JBIG schemes for decoding.

A display unit 51 includes a Liquid Crystal Display (LCD) The display unit 51 includes a touch screen function which can designate a position on a screen by touching the screen with a finger or an exclusive pointer. A user can carry out an instruction by using the touch screen function of the display unit 51 in accordance with the content displayed on the display unit 51. Accordingly, a prescribed operation can be executed by the image forming device 1. As described above, the display unit 51 is used as an input unit which enables prescribed data to be input to the image forming device 1.

The operation unit 52 is an input unit which includes a keyboard and a mouse, for example. The user performs an input operation in accordance with the content displayed on the display unit 51. Accordingly, a prescribed operation can be executed by the image forming device 1.

A read port 53 includes a photo-coupler. For example, the photo-coupler includes a pair of a light emitting diode and a photo diode. The read port 53 senses a switched-on state or a switched-off state of the cover open sensor 6 and the drum unit installation sensor 66 or the like as a digital value, which can be handled by a Micro Processing Unit (MPU) 11.

For example, when the drum unit 61 is not installed properly and the drum unit installation sensor 66 is switched off, an electric current does not flow to the light emitting diode of the corresponding photo-coupler, and an electric current does not generate in the photo diode. Accordingly, the MPU 11 can determine that the drum unit installation sensor 66 is switched off.

Meanwhile, when the drum unit 61 is installed properly and the drum unit installation sensor 66 is switched on, an electric current flows to the light emitting diode of the corresponding photo-coupler, and an electric current generates in the photo diode. Accordingly, the MPU 11 can determine that the drum unit installation sensor 66 is switched on.

As described above, the cover open sensor 6 functions as a sensing unit, which senses whether the cover 7 is opened or closed. The drum unit installation sensor 66 functions as a sensing unit, which senses whether or not the drum unit 61 is installed.

A Static Random Access Memory (SRAM) 12 is preferably a writable non-volatile memory. For example, the SRAM 12 stores a telephone number registered by being associated with a speed-dial number by the user. The image memory 16 is a writable memory. The image memory 16 stores digital image data, which has been input to the image forming device 1 via the scanner 21 and the MODEM 32.

A Read Only Memory (ROM) 13 is a memory exclusive for reading. The MPU 11 executes a control in accordance with a program stored in the ROM 13. The MPU 11 is electrically connected to the ROM 13, a printer mechanism control circuit 44 and the read port 53 or the like via a buss line 15. Therefore, in accordance with the program stored in the ROM 13, the MPU 11 can execute a reading process of the read port 53 and a processing of the laser scan unit 70, which is carried out by the printer mechanism control circuit 44, under a prescribed timing.

Further, in the present preferred embodiment, the program for controlling an operation of the image forming device 1 is stored in the ROM 13. However, the present invention shall not be limited to this example. For example, the program may be stored in a flash memory, for example, which is a writable non-volatile memory.

2. Procedure for Initializing the Image Forming Device

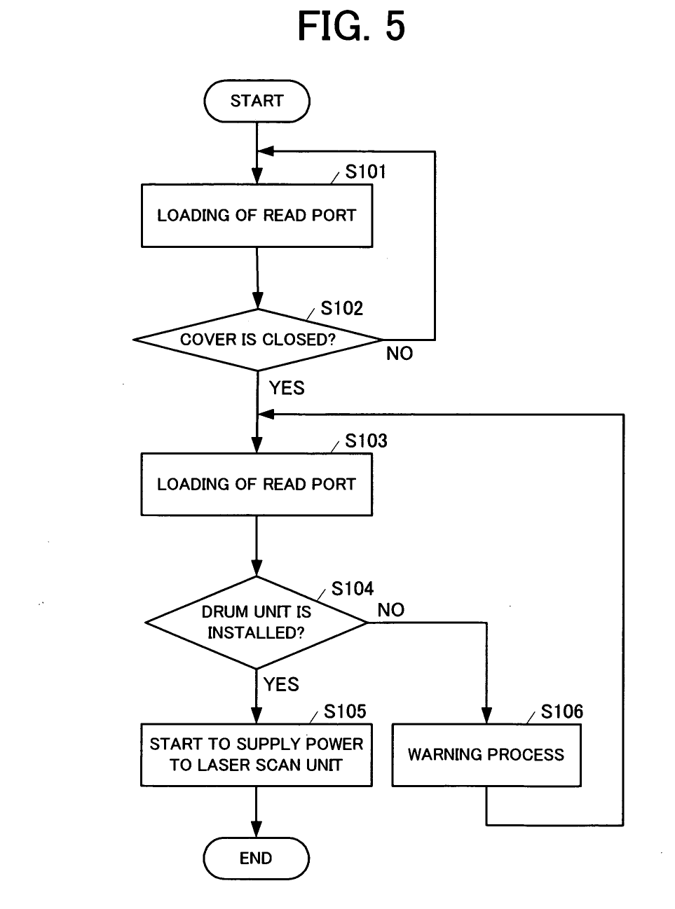

FIG. 5 is a flowchart illustrating an example of a procedure for initializing the image forming device 1 according to the present preferred embodiment of the present invention. With reference to FIG. 5, a description will be made of a processing for starting to supply power to the laser diode 71 of the laser scan unit 70 in the procedure for initializing the image forming device 1. Further, for convenience of description, it is supposed that the cover 7 is opened prior to the execution of this procedure.

In this procedure, first, a digital value of an input element corresponding to the cover open sensor 6 among input elements of the read port 53 is loaded (step S101). In accordance with the loaded digital value, when a determination is made that the cover open sensor 6 is switched off and the cover 7 is open (step S102), the display unit 51 displays a message urging to close the cover 7. Until the cover 7 is closed, the processes of step S101 and step S102 are repeated.

When the cover 7 is closed, an input element corresponding to the drum unit installation sensor 66 among the input elements of the read port 53 is loaded (step S103). In accordance with the loaded digital value, when a determination is made that the drum unit 61 is installed properly (step S104), the drum unit installation sensor 66 is switched on. That is, power is supplied from the 5V power supply unit 67 to the laser diode 71 (step S105).

Therefore, the laser diode 71 becomes capable of irradiating a laser light on the photoconductive drum (not illustrated) of the drum unit 61. As a result, the MPU 11 becomes capable of executing a printing process on the process unit 60 and the laser scan unit 70, and the initialization process ends.

As described above, according to the present preferred embodiment, one drum unit installation sensor 66 can execute a function as a sensing unit for sensing an installation state of the drum unit 61 and can also a function as a switching unit for supplying or shutting off power to the laser diode 71 of the laser scan unit 70.

Meanwhile, when a determination is made that the drum unit 61 is not installed properly, the drum unit installation sensor 66 is switched off, and the supply of power to the laser diode 71 is not started. That is, since the image forming device 1 cannot execute the printing process, the display unit 51 displays a message urging to install the drum unit 61 properly. Until the drum unit 61 is installed properly, the processes of steps S103, S104, and S106 are repeated. Further, until the drum unit 61 is installed properly, power is not supplied to the laser diode 71, and a laser light is not irradiated mistakenly from the laser diode 71.

3. Advantages of the Image Forming Device of the Present Preferred Embodiment

As described above, the image forming device 1 according to the present preferred embodiment can execute a switching process for supplying or shutting off the power to the laser diode 71 and the sensing process for sensing the installation state of the drum unit 61 by one drum unit installation sensor 66. Until the drum unit 61 is installed properly, power is not supplied to the laser diode 71, and the laser light is not irradiated mistakenly from the laser diode 71. Therefore, while maintaining the safety of the image forming device 1, a hardware structure of the image forming device 1 can be simplified and a cost required for manufacturing the image forming device 1 can be reduced.

Until the drum unit 61 is installed properly, the laser light is not irradiated from the laser diode 71. Therefore, the laser scan unit 70 can satisfactorily execute an image forming process on the drum unit 61.

4. Other Preferred Embodiments

A preferred embodiment of the present invention has been described above. The present invention is not limited to the above-described preferred embodiment. There exist various modifications to the above-described preferred embodiment.

In the above-described preferred embodiment, the drum unit installation sensor 66 senses the installation state of the drum unit 61. However, the present invention is not limited to this example. For example, the drum unit installation sensor 66 may sense the installation state of the drum unit 61 and the developing unit 62. When the image forming device 1 includes the process unit 60 in which the drum unit 61 and the developing unit 62 are integral, the drum unit installation sensor 66 may sense the installation state of the integral process unit 60. That is, the drum unit installation sensor 66 senses at least an installation state of the drum unit 61, which receives the laser light from the laser scan unit 70.

The above particular embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An image forming device, comprising:
a casing which includes a cover capable of being opened and closed;
a process unit which is arranged inside the casing and executes a printing process on a printing medium;
an image forming unit which is arranged inside the casing and forms an electrostatic latent image on the process unit;
a control unit which controls an operation of the process unit and the image forming unit;
a first switch which senses an installation state of the process unit; and
a power supply unit which supplies power to the image forming unit when the process unit is installed and the first switch is activated.

2. The image forming device according to claim 1, further comprising a laser diode included in the image forming unit.

3. The image forming device according to claim 2, further comprising a polygon mirror which reflects a laser light from the laser diode and scans a photoconductor by the laser light.

4. The image forming device according to claim 1, further comprising a drum unit which is included in the process unit and includes a photoconductive drum.

5. The image forming device according to claim 1, further comprising a first read port which transmits a signal, indicating that the first switch has been activated, to the control unit.

6. The image forming device according to claim 1, wherein the first switch includes a mechanical contact.

7. The image forming device according to claim 5, further comprising a photo-coupler which converts a signal of the first switch into a signal capable of being processed by the control unit in the first read port.

8. The image forming device according to claim 1, further comprising:
a second switch which senses an opened and a closed state of the cover; and
a read port which transmits a signal of the second switch to the control unit;
wherein the control unit determines whether or not the first switch has been activated.

9. The image forming device according to claim 8, further comprising a photo-coupler which converts the signal of the second switch into a signal capable of being processed by the control unit in the second read port.

10. An image forming device, comprising:
means for forming an electrostatic latent image on a photoconductor;
means for executing a printing process on a printing medium; and
means for sensing an installation state of the photoconductor, and upon sensing the installation state of the photoconductor, permitting an electrostatic latent image to be formed on the photoconductor.

11. The image forming device according to claim 10, further comprising means for scanning the photoconductor by a laser light for forming the electrostatic latent image on the photoconductor.

12. The image forming device according to claim 11, wherein the means for sensing an installation state includes means for connecting the means for scanning by the laser light to a power supply unit when the photoconductor is installed.

13. The image forming device according to claim 10, further comprising means for sending a signal indicating an installation state of the photoconductor to a control circuit.

14. The image forming device according to claim 13, further comprising means for generating a warning when the control circuit determines that the photoconductor is not installed.

15. The image forming device according to claim 14, further comprising:
means for covering an opening of a casing in a manner capable of being opened and closed;
means for sensing that the opening is closed; and
means for starting a determination of an installation of the photoconductor when the means for sensing senses that the opening is closed.

16. An image forming method, comprising the steps of:
installing a process unit into a casing which switches on a switch;
connecting a laser light source to a power supply unit through the switch;
activating the laser light source and forming an electrostatic latent image on a photoconductor; and
developing the electrostatic latent image.

17. The image forming method according to claim 16, further comprising the step of detecting that a cover of the casing has been closed.

18. The image forming method according to claim 16, further comprising the step of generating a warning when the cover is closed and the switch is not switched on.

19. The image forming method according to claim 18, further comprising the step of prohibiting an operation of the laser light source.

20. The image forming method according to claim 16, further comprising the steps of:
transmitting a signal, which indicates that the switch has been switched on, to a control circuit; and
operating the laser light source by the control circuit.
